(19) United States
(12) Patent Application Publication
(10) Pub. No.: US 2005/0160035 A1
(43) Pub. Date: Jul. 21, 2005

(54) Credit transaction system

(76) Inventor: Nobukazu Umamyo, Osaka (JP)

Correspondence Address: MCDERMOTT WILL & EMERY LLP, 600 13TH STREET, N.W., WASHINGTON, DC, 20005-3096, US

(21) Appl. No.: 10/987,206

(22) Filed: Nov. 15, 2004

(30) Foreign Application Priority Data
Nov. 17, 2003 (JP) 2003-386139

(51) Int. Cl. G06F 17/60

(52) U.S. Cl. 705/39

(57) ABSTRACT

A credit transaction system for adjusting the amount of money that can be used for credit according to the payment capability of the member, even when the credit limit for purchasing a product or receiving provided services with a credit card is set. In this system, in response to an application for a credit transaction, a computer calculates an adjusted unused balance based on an a preset adjustment rate for the credit limit of the member applying for the transaction, and based on a result of comparing the calculated adjusted unused balance with the transaction amount, the computer sets whether or not to allow the transaction.

### BACKGROUND OF THE INVENTION

1. Field of the Invention

This invention relates to a credit transaction system for setting whether or not to accept a credit application for purchase of a product or provided services on credit.

2. Description of the Related Art

When a transaction is performed using a credit card, card information, such as the credit card number of the presented credit card is read by a CAT (Credit Authorization Terminal) or POS (Point of Sales) terminal that is located at a member shop. For example, as disclosed in Japanese unexamined patent publication No. 2000-163476, the read card information or the transaction information is sent to the computer at the credit company by way of a public access line or a network that connects with the card center and credit company. Based on the received information, the computer at the credit company sets whether or not to allow the credit transaction for which there was an application. In order to do that, the computer compares the transaction amount and the unused balance with the credit limit of the card member making the credit application. The credit company determines the credit limit after examining the payment capability of the member based on the member's income, family structure, length of employment and the like at the time when the member applied for card membership. When the unused balance is no less than the transaction amount and other conditions are satisfied, the credit transaction is allowed. However, when the unused balance is less than transaction amount, the transaction is not allowed, even when all other conditions are satisfied. The result of this determination is transmitted from the computer at the credit company to the CAT or POS terminal. After approval has been received from the credit company for the transaction, the member can purchase and receive the product without having to pay the cost of the product by signing the credit application. The credit company temporarily pays the cost of the product for the member, and then the member pays that amount to the credit company at a later date.

### SUMMARY OF THE INVENTION

A relative amount of time is taken to set the credit limit discreetly and carefully after the member has joined. After that, it is very difficult to frequently change the credit limit for a large number of members taking into consideration the payment capability of each member. Therefore, even though the payment capability of a member is actually a little higher than the credit limit, it was only possible for the member to make a credit transaction with the credit limit that was set at the time the member joined.

Taking the problems with the prior art into consideration, the object of this invention is to provide a credit transaction system that is capable of easily adjusting the amount that a member can use based on the member's payment capability, even though a credit limit for the member has been set.

The credit transaction system of this invention employs the following construction in order to accomplish the object described above.

In the credit transaction system, a calculation unit calculates an adjusted unused balance based on a preset adjustment rate for the credit limit of the member applying for a credit transaction. The adjustment rate may be a value that is read from a storage device for the user. A setting unit sets whether or not to allow the transaction based on a comparison result between the calculated adjusted unused balance and the transaction amount.

In the system, in response to an application for a credit transaction, a determination unit can determine whether or not to adjust the credit limit of the member making the application, based on the payment information of the member. The adjustment can be performed for each individual transaction, and thus it is not necessary to change the member's credit limit itself by the adjustment. In this case, when it is determined to adjust the member's credit limit for the transaction, the calculation unit calculates an adjusted unused balance based on a preset adjustment rate for the credit limit. By determining whether or not to adjust the credit limit for each individual credit transaction application based on the member's payment information in this way, the amount that can be used for credit is adjusted to according to the member's payment status at the time of the application.

By employing the construction described above, with this invention it is possible to adjust the credit limit for a credit transaction application based on a preset adjustment rate. Since the payment capability of the member is reflected in the adjustment rate for the credit limit, it is possible to easily adjust the credit limit according to the member's payment capability.

From another aspect, this invention provides a credit transaction method. The method comprises the steps of: a computer calculating an adjusted unused balance based on a preset adjustment rate for the credit limit of the member applying for a credit transaction; and a computer setting whether or not to allow the transaction based on a comparison result between the calculated adjusted unused balance and the transaction amount.

From still another aspect, this invention provides a computer readable medium bearing a program that causes a computer to execute the steps described above.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a drawing for illustrating the basic construction of the credit transaction system of an embodiment of this invention.

FIG. 2 is a flowchart for explaining the credit transaction method of an embodiment of this invention.

FIG. 3 is a drawing showing the functional blocks of the credit transaction system of an embodiment of this invention.

FIG. 4 is a drawing for showing a concrete example of credit information.

FIG. 5 is a drawing for explaining the results of setting whether or not to approve credit applications from members of different deposit classifications.

FIG. 6 is drawing showing a detailed example of a screen for checking the credit information and adjusted unused balance.

FIG. 7 is a flowchart for explaining another example of a credit transaction method.

FIG. 8 is a flowchart for explaining yet another example of a credit transaction method.

FIG. 9 is a flowchart for explaining even yet another example of a credit transaction method.

### DESCRIPTION OF THE PREFERRED EMBODIMENTS

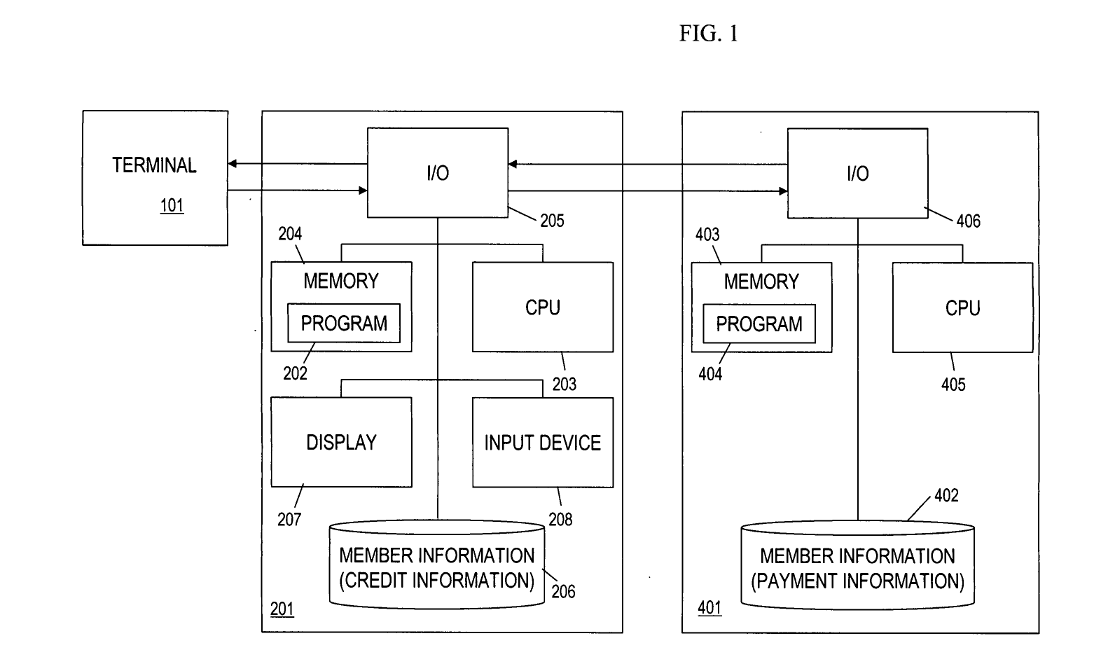

FIG. 1 shows the basic construction of the credit transaction system of an embodiment of the invention. As shown in FIG. 1, in the credit transaction system of this embodiment, a terminal 101, such as a CAT or POS terminal, is connected to the computer 201 of a credit company by way of a telecommunication line such as a public access line, or a network with the credit company.

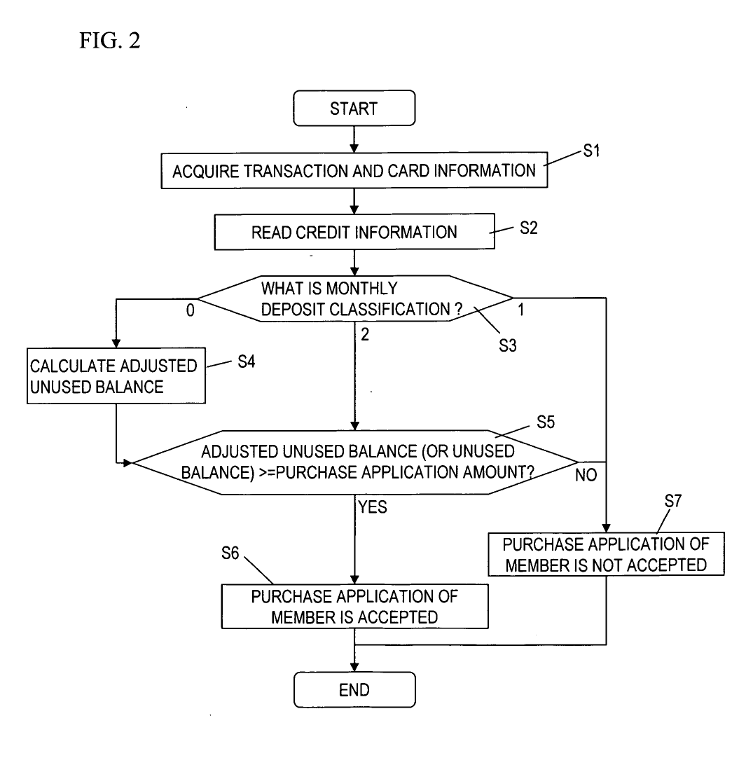

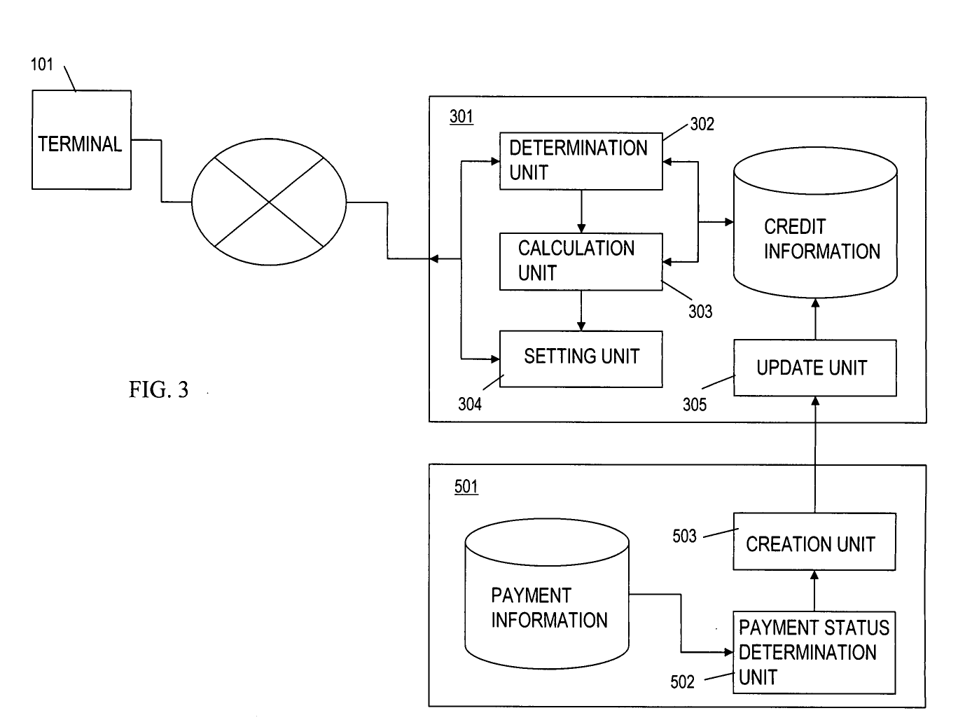

A program 202 runs on the computer 201 to process credit transaction applications that are received from the terminal 101. The application for a credit transaction is received, a CPU (Central Processing Unit) 203 of the computer 201 follows instructions from the program 202 that is read to a memory 204, and executes a procedure as shown in FIG. 2. At this time, by operating together with the program 202, the computer 201 functions as a credit transaction apparatus 301 that comprises units as shown in FIG. 3.

After receiving transaction information such as a transaction amount, and card information from the terminal based on a credit transaction application, the CPU 203 functions as a determination unit 302 and determines whether or not to adjust the credit limit of the member making the application based on the payment information of the member.

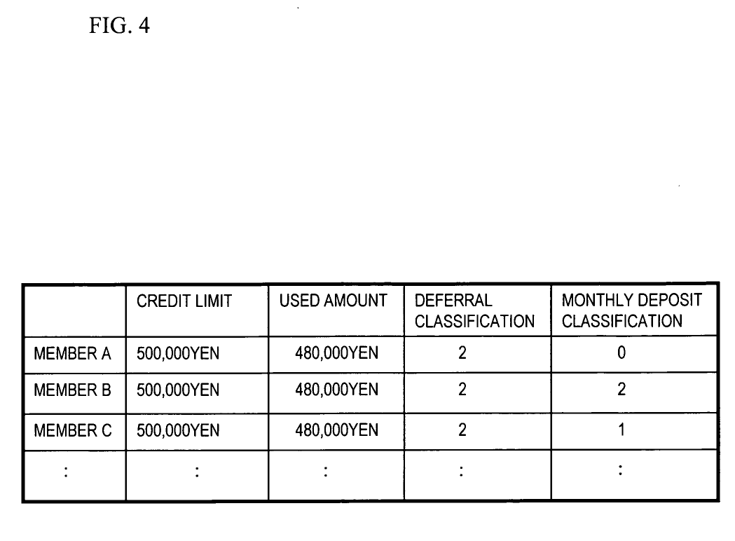

After obtaining transaction information and card information from the I/O 205 (S1), the CPU 203 identifies the member making the application from the card information, and reads the credit information corresponding to the member from a storage device 206 (S2). In the storage device 206 of the computer 201, credit information is stored. As shown in FIG. 4, the credit information contains the credit limit, used amount and monthly deposit classification, for each member. The used amount is the total amount of the credit transactions made by the member from the time of the previous month's payment withdrawal to the present time. The monthly deposit classification is set to correspond with the payment information of the member, and indicates the payment status of the member. Here, the monthly deposit classifications are expressed by the three numbers, ‘0’, ‘1’ and ‘2’. Classification ‘0’ indicates that deposits are being made properly, or that the withdrawal date has not yet arrived. Classification ‘1’ indicates that there was no withdrawal even though there were no special circumstances. Classification ‘2’ indicates that there was no withdrawal due to special circumstances. In the example shown in FIG. 4, the monthly deposit classification for member A is ‘0’, the monthly deposit classification for member B is ‘2’, and the monthly deposit classification for member C is ‘1’. The other data for the three members is the same.

The CPU 203 determines whether or not to adjust the credit limit based on the read monthly deposit classification (S3). When the read monthly deposit classification is ‘0’, the CPU 203 determines to adjust the applying member's credit limit for the application. When the read monthly deposit classification is ‘2’, the CPU 203 determines not to adjust the credit limit of the member. Moreover, in this embodiment, when the read monthly deposit classification is not ‘1’, the CPU 203 determines that the credit limit of the member is valid, and when the read monthly deposit classification is ‘1’, the CPU 203 determines that the credit limit of the member is invalid.

When the above members A through C make credit applications, the CPU 203 determines to adjust the credit limit for the application made by the member A, but determines not to adjust the credit limit for the application made by the member B. Also, the CPU 203 determines that the credit limits for both member A and member B are valid, and determines that only the credit limit of the member C is not valid.

When the CPU 203 determines to adjust the credit limit for a member, the CPU 203 functions as a calculation unit 303 and calculates an adjusted unused balance based on a preset adjustment rate for the credit limit (S4).

In this embodiment, the adjustment rate is expressed as the ratio of the difference between the adjusted credit limit and credit limit with respect to the credit limit. A deferral classification for specifying the adjustment rate is also contained in the credit information, and the CPU 203 sets the adjustment rate based on the read deferral classification of the credit information. The deferral classification can also be given a number value such as a single digit number. Here, a deferral classification value of ‘2’ indicates that the adjustment rate is 10%. The CPU 203 multiplies the read credit limit by the adjustment rate corresponding to the read deferral classification to calculate the adjustment value for the credit limit. Moreover, the CPU 203 adds the adjustment value to the credit limit to calculate an adjusted credit limit. In the case where the read credit limit is 500,000 yen, the adjustment value becomes 10% of that, or in other words, 50,000 yen, and the adjusted credit limit becomes 550,000 yen.

The adjustment rate can also be defined as the ratio of the adjusted credit limit with respect to the credit limit. In that case, the CPU 203 multiplies the read credit limit by the adjustment rate that corresponds to the read deferral classification to adjust the credit limit. When the deferral classification ‘2’ corresponds to a ratio of 110%, the value after adjusting the 500,000 yen credit limit is 550,000 yen.

After calculating the adjusted credit limit, the CPU 203 calculates the unused balance by subtracting the read used amount from the adjusted credit limit. In the case where the read used amount is 480,000 yen, in the example above, the unadjusted unused balance becomes 20,000 yen, however, since the adjusted credit limit is 550,000 yen, the adjusted unused balance becomes 70,000 yen.

After calculating the adjusted unused balance, the CPU 203 functions as a setting unit 304 and compares the calculated unused balance with the obtained transaction amount (S5). The CPU 203 then sets whether or not to allow the transaction based on the comparison result.

In the case where the adjusted unused balance is no less than the obtained transaction amount, the CPU 203 sets to allow that transaction (S6), however, when the adjusted unused balance is less than the transaction amount, the CPU 203 sets not to allow the transaction (S7). The result of this decision is sent from the computer 201 to the terminal 101.

In this example, when the unused balance is equal to the credit limit, the adjusted unused balance becomes greater than the credit limit. In the case of a member having good payment status, it is possible for the member to purchase products or receive provided services that exceed the credit limit or the unused balance at that time. Moreover, the adjustment amount for the credit limit is set based on a preset adjustment rate. The credit limit is an amount set according to the payment capability of the member, and the adjustment amount that is set based on the adjustment rate is proportional to the credit limit. Therefore, even in the case where only one deferral classification value is prepared, it is possible to easily calculate an adjustment amount that corresponds to the payment capability of the member.

On the other hand, if for some circumstance there has been no payment withdrawal, it is not possible for the member to purchase products or receive provided services that exceed the credit limit or the unused balance at that time. When the monthly deposit classification is ‘2’ and the CPU 203 determines not to adjust the credit limit for the member, the CPU 203 then functions as a setting unit 304 and compares the unused balance, which is the value obtained by subtracting the used amount from the read credit limit, with the transaction amount (S5). The CPU 203 sets whether or not to allow that transaction based on the comparison result.

When the unused balance is greater than the transaction amount, the CPU 203 sets to allow the transaction (S6), however, when the unused balance is less than the transaction amount, the CPU 203 sets not to allow the transaction (S7).

Also, when the monthly deposit classification is ‘1’ and the CPU 203 determines that the credit limit for the member is invalid, the CPU 203 then functions as the setting unit 304 and sets not to allow the transaction (S7). When the credit limit is determined to be invalid, the credit limit is handled as if it were ‘0’. Regardless of the amount of the credit application, the CPU 203 sets not to allow the transaction.

The result of this setting is also sent from the computer 201 to the terminal 101. When the CPU 203 has determined not to adjust the credit limit of the member, the member can purchase products or receive provided services as normal within the range of the unused balance. When the CPU 203 determines that the credit limit of the member is invalid, then the member is not able to make a credit transaction.

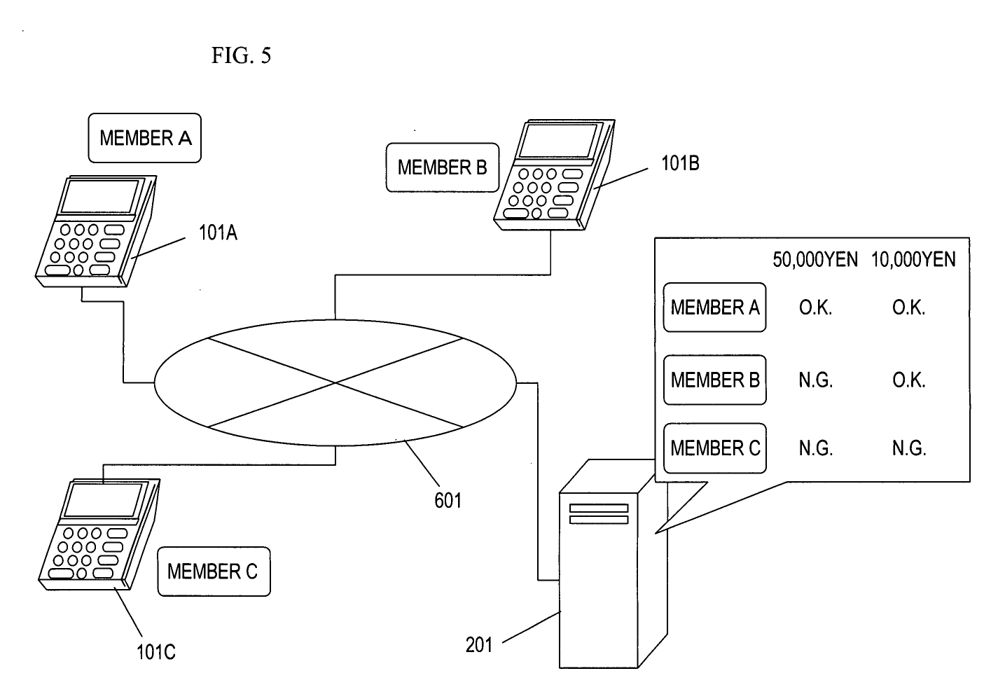

Even when the credit information is the same as in the case of the members A through C except the monthly deposit classification, if the value of the classification is different, the CPU 203 will set to allow or not to allow the transaction for the application depending on the classification. In the example shown in FIG. 5, the terminals 101A to 101C that are used by the members A to C are connected to the computer 201 via a network 601. The members A to C use those terminals 101A to 101C to apply to use 50,000 yen. Since the credit limit of member A has been increased to 550,000 yen for the application, having a used amount of 480,000 yen up to that time, the CPU 203 sets to allow the transaction of member A's application. Data indicating that the transaction of the application has been allowed is sent from the computer 201 to the terminal 101A. The credit limit for the member B is not changed and remains at 500,000 yen. Therefore, if the used amount up to that time is 480,000 yen, then the unused balance is less than the transaction amount. Therefore, even though the member B's credit limit is valid, the CPU 203 sets not to allow the transaction of the member B'sapplication. The credit limit for the member C is invalid, so the CPU 203 sets not to allow the transaction of the member C's application. Data indicating that the transactions of those applications have not been allowed is sent from the computer 201 to the respective terminals 101B and 101C.

In the case where the transaction amount of the application is 10,000 yen, the CPU 203 only sets to not allow the transaction of member C's application. Of course, in this case, the transaction amount of the member A's application is less than 50,000 yen, so the CPU sets to allow the transaction of the application. Moreover, when the transaction amount of the member B's application is 10,000 yen, the amount is less than the unused balance of 20,000 yen, so the CPU 203 sets to allow the transaction of the application without adjusting the unused balance. The credit limit of the member C is invalid, so even though the transaction amount of the application is small, the CPU sets to not allow the transaction of the application as long as the credit limit is invalid.

Adjustment of the credit limit described above is performed for individual credit applications, and even though a member's credit limit was adjusted in the past for past applications, it is possible that adjustment of that member's credit limit may not be performed for future credit applications due to changes in payment status. The member's credit information that is stored in the storage device 206 does not have to be changed due to the adjustment.

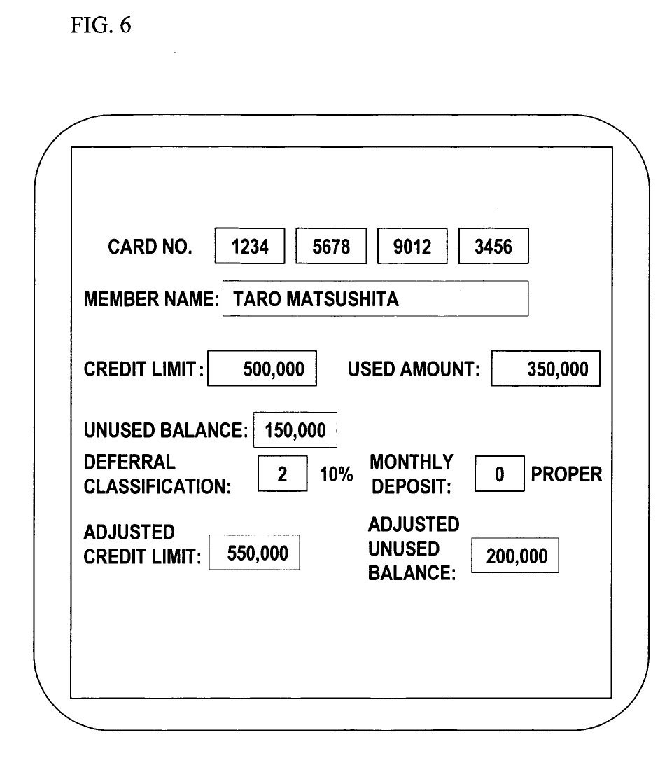

With this kind of system, the credit information and other calculated information can be referenced or changed by an operator of the credit company having proper authorization. FIG. 6 shows an example of a screen that is displayed on the display 207 of the computer 201 when an operator references credit information. On this screen, the credit card number and member's name, credit limit, unused balance, monthly deposit classification, adjusted credit limit, adjusted unused balance, and the like are displayed on this screen. When necessary, the operator can use an input device 208 such as a keyboard or a mouse to make changes to the value of the monthly deposit classification or deferral classification.

The monthly deposit classification can also be such that it is automatically updated according to the payment status. As shown in FIG. 1, in this system, a computer 401 for managing the payment information of the members is connected to the computer 201. The payment information for each member is stored in the storage device 402 of the computer 401. A CPU 405 of the computer 401 functions as a payment status determination unit 502 of the payment information management apparatus 501 shown in FIG. 3 according to instructions from a program 404 in a memory 403. The CPU 405 timely reads the payment information from the storage device 402 and determines the payment status. Moreover, the CPU 405 functions as a creation unit 503 and creates monthly deposit classification data from the determination result. This data is sent to the computer 201 via the I/O 406.

After the computer 201 receives the monthly deposit classification data, the CPU 203 functions as an update unit 305 and updates the setting for the monthly deposit classification that is contained in the credit information in the storage device 206 according to the data obtained via the I/O 205.

By updating the monthly deposit classification in this way, it is possible to accurately determine whether or not to adjust the credit limit of a member even when there are changes in the payment status of the member.

Furthermore, the deferral classification can be automatically updated according to the payment status for a set period. This set period is a period containing a plurality of opportunities for payment. For example, when a member has the opportunity to make monthly payments, then this period is set as six months or year. In order to update the deferral classification, first, the CPU 405 functions as a payment status determination unit 502 and checks the number of times payments are made for credit that is no less than the credit limit and no more than the adjusted credit limit based on payment information for the member each time a period elapses. When payments are made a set number of times for credit that is no less than the credit limit and no more than the adjusted credit limit, the CPU 405 functions as a creation unit 503 and creates data to update the deferral classification. This update data is data indicating that the value of the deferral classification has been increased by just one, and it is sent from the computer 401 to the computer 201. After receiving the data from the computer 401, the CPU 203 of the computer 201 functions as an update unit 305 and updates the setting for the deferral classification for the corresponding member based on the received data. By this update, the deferral classification value is updated from ‘2’ to ‘3’ for example. Here, the deferral classification value ‘3’ indicates that the adjustment rate is 15% (or 115%).

By updating the adjustment rate according to the payment status in this way, it becomes possible to adjust the credit limit according to the payment capability of the member.

In the explanation above, the credit limit or unused balance was increased by adjustment, however, it is also possible to reduce them by using a negative adjustment rate.

Furthermore, when there is an application for a credit transaction, instead of always performing a judgment to determine whether or not to adjust the member's credit limit, it is also possible to perform that judgment only when the used amount is no less than a specified amount. Moreover, it is also possible to perform that judgment only when there is an application for a credit transaction at a specified time, such as in the month of the member's birthday or at the end of the year, when there is an application to purchase a specified product or to receive a specified service, when there is an application from a specified affiliated shop or by way of another specified application route, etc. In the case of applications for which these kinds of conditions are not met, a setting can be performed to set whether or not to allow the application based on the normal credit limit or unused balance. For example, when there is a credit application to purchase airline tickets or a tour package for an overseas trip on credit, judgment is performed to determine whether or not to adjust the credit limit of the member making the application for the application and other applications up until the time the member returns from the trip. After the member returns from the trip, judgment is then performed to determine whether or not to allow applications based on the normal credit limit or unused balance.

Instead of the payment information of the member, judgment to determine whether or not to adjust the member's credit limit can also be performed based on other information that indicates the payment capability of the member. For example, when an IC card is used on the credit card, and that IC card makes it possible to provide both the function of a cash card and a credit card, by obtaining bank balance information that is stored on the IC card for the cash card function, it is also possible for the computer of the credit company to perform judgment based on the bank balance.

Furthermore, instead of performing a credit transaction using a credit card, it is possible to use a portable telephone or other device that has a credit function.

Moreover, in the explanation above, the application for a credit transaction was performed from a CAT or POS terminal, however, the invention is not limited to this. The credit company's computer may set whether or not to allow a credit application that was received from the member's computer via the Internet. Furthermore, by having an operator enter the contents of an application over the telephone or from a purchase application form, the credit company's computer can set whether or not to allow the application.

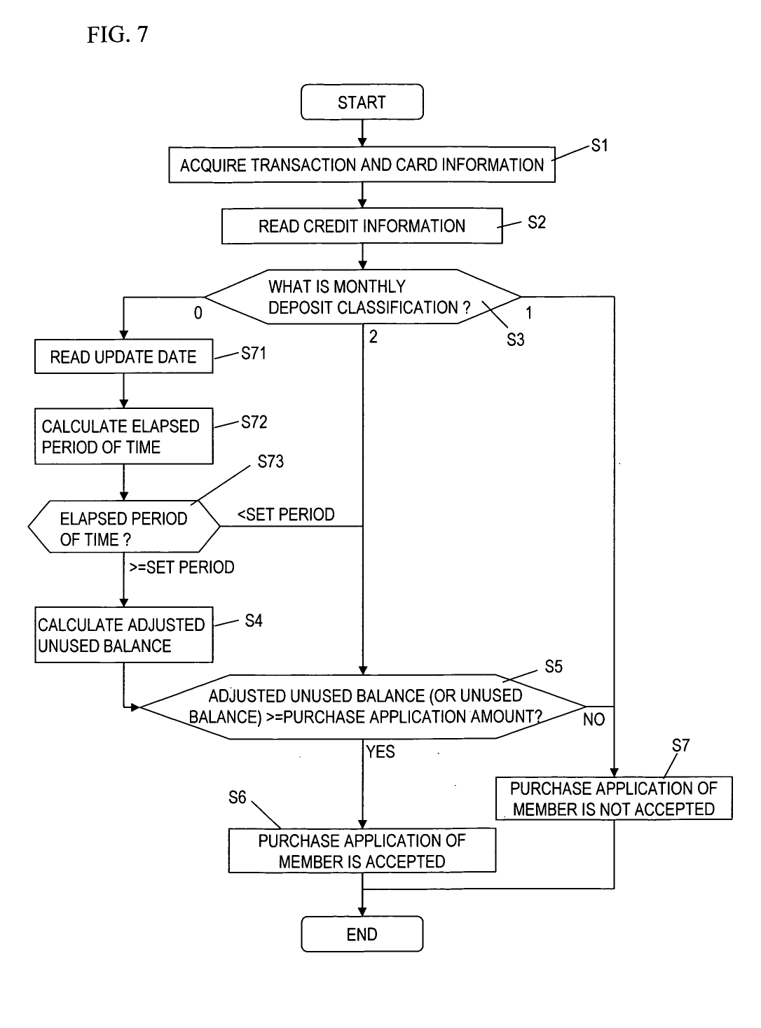

Also, when the update unit 305 updates the monthly deposit classification value, it is possible to record data of the monthly deposit classification value before the update and data of the date indicating the update period of the monthly deposit classification value as a part of the credit information. The recorded data for the monthly deposit classification before update and the update-date can be used in the judgment by the determination unit 302. As shown in FIG. 7, even when the monthly deposit classification at that time is ‘0’, the CPU 203 determines to adjust the applying member's credit limit for the application only if the elapsed period of time since the monthly deposit classification became ‘0’ satisfies certain conditions. When the monthly deposit classification at that time is ‘0’, the CPU 203 reads update-date data from the storage device 206 (S71), and calculates the elapsed period of time from the update date and the current date (S72). The CPU 203 performs judgment based on the elapsed period of time and a preset period of time (S73). When the elapsed period of time is no less than the set period of time, the CPU 203 determines to adjust the applying member's credit limit for the application, however, when the elapsed period of time is less than the set period of time, the CPU 203 determines not to adjust the member's credit limit for the application.

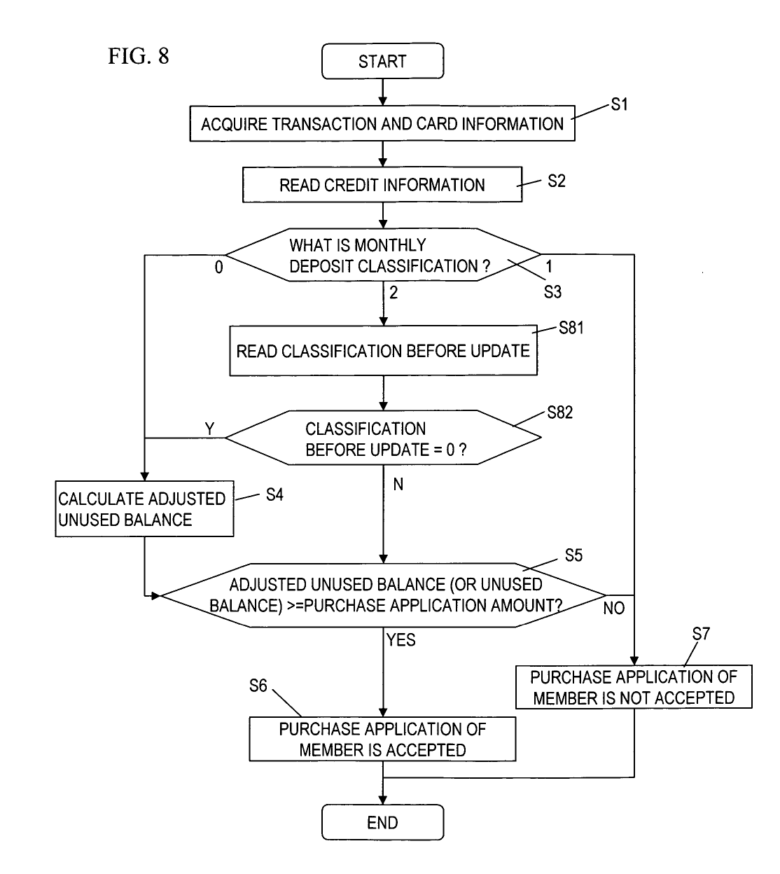

Also, as shown in FIG. 8, even when the monthly deposit classification at that time is ‘2’, it is possible to determine to adjust the applying members credit limit if conditions related to the monthly deposit classification before the update are met. When the monthly deposit classification is ‘2’, the CPU 203 reads the data for the monthly deposit classification before the update from the storage device 206 (S81), and determines whether or not the read value before update is ‘0’ (S82). When the value before update is not ‘0’, the CPU 203 determines not to adjust the applying member's credit limit for the application. On the other hand, when the value before update is ‘0’, the CPU 203 determines to adjust the applying member's credit limit for the application.

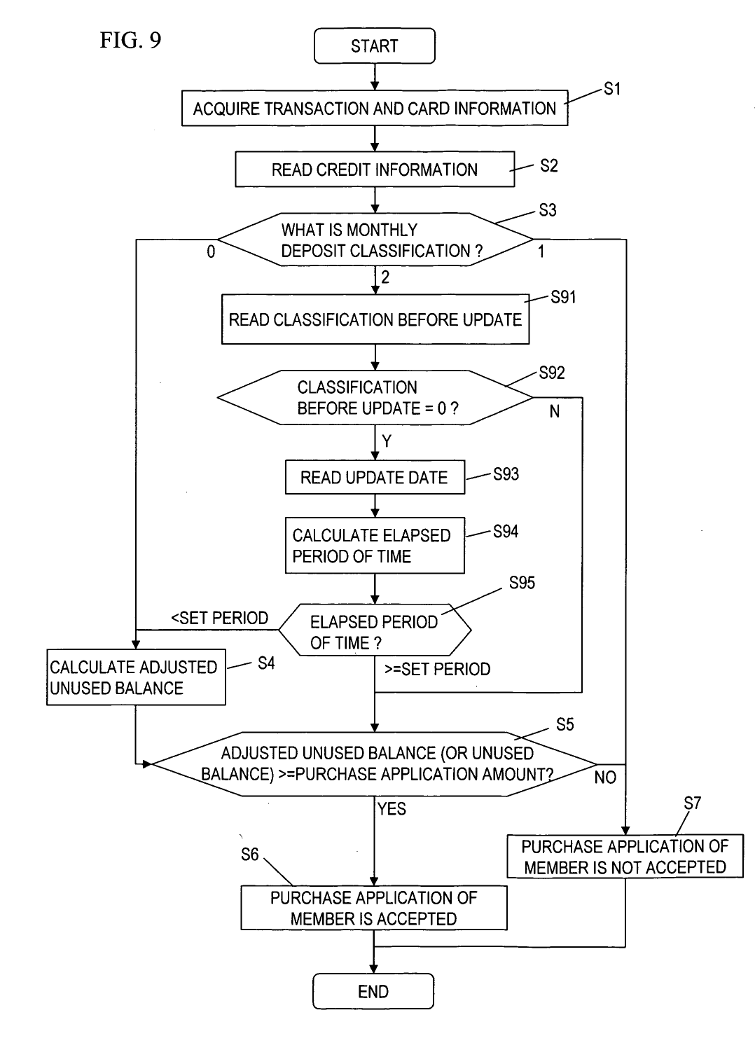

Furthermore, as shown in FIG. 9, even when the monthly deposit classification at that time is ‘2’, the CPU 203 can determine to adjust the applying member's credit limit for the application when conditions related to the elapsed period of time and monthly deposit classification before update are met. In this case as well, the CPU 203 reads data for the monthly deposit classification before update from the storage device 206 (S91), and determines whether or not the value before update is ‘0’ (S92). When the value before update is not ‘0’, the CPU 203 determines not to adjust the applying member's credit limit for the application. When the value before update is ‘0’, the CPU 203 reads the data for the update date from the storage device 206 (S93), and calculates the elapsed period of time from the date and the current date (S94). The CPU 203 compares the elapsed period of time with a preset period of time (S95). When the elapsed period of time is no less than the set period of time, the CPU 203 determines not to adjust the applying member's credit limit for the application, however, when the elapsed period of time is less than the set period of time, the CPU 203 determines to adjust the applying member's credit limit for the application.

By using the elapsed period of time or deposit classification before update in this way to change the judgment based on the deposit classification at that time, it is possible to reflect the payment history up to that time on the judgment result.

Also, in the embodiment described above, the programs 202 and 404 are run on the respective computers 201 and 401, however, each program can also be run on a plurality of computers.

In the case where the programs 202 and 404 are to be provided to a third party, they can be provided by way of a telecommunications line such as the Internet, or those programs can be recorded onto a computer readable storage medium, and then they can be provided by distributing the storage medium. By expressing the instructions of a program as an electrical, optical or magnetic signal, for example, and then sending the signal on a carrier wave, it is possible to provide the program via a communications line that uses a coaxial cable, copper wire or optical fiber. It is also possible to use wireless communication or infrared communication to send the signal. Moreover, it is possible to use an optical medium such as a CD-ROM or DVD-ROM, a magnetic medium such as a floppy disk, or a semiconductor memory such as a flash memory or RAM as the computer readable storage medium.

The credit transaction system of this invention is effective in making it possible to easily adjust the amount of money that can be used for credit according to the payment capability of the member, even when the credit limit for purchasing products or receiving provided services on credit is set, and it is useful in various kinds of credit transactions.

The disclosure of Japanese Patent Application No. 2003-386139 filed Nov. 17th, 2003 including specification, drawings and claims is incorporated herein by reference in its entirety.

The embodiments described above do not limit the technical scope of the invention, and in addition to the embodiments described above, the embodiments can be changed or applied in various ways within the scope of the invention.

1. A credit transaction system comprising:
a calculation unit configured to calculate an adjusted unused balance based on a preset adjustment rate for a credit limit of a member applying for a credit transaction; and
a setting unit configured to set whether or not to allow the transaction based on a comparison result between the calculated adjusted unused balance and a transaction amount.

2. The credit transaction system of claim 1, further comprising a determination unit configured to, in response to an application for a credit transaction, determine whether or not to adjust a credit limit of a member making the application based on payment information of the member,
wherein said calculation unit, in the case of said determination unit determining to adjust the credit limit of the member, calculates an adjusted unused balance based on a preset adjustment rate for the credit limit.

3. The credit transaction system of claim 2, further comprising a storage device storing a preset adjustment rate for a credit limit of a member,
wherein said calculation unit calculates an adjusted unused balance based on the adjustment rate that is read from the storage device for a credit limit of a member applying for a credit transaction.

4. The credit transaction system of claim 2 wherein said determination unit determines whether or not a credit limit of a member is valid based on payment information of the member, said setting unit, in the case of said determination unit determining that the credit limit of the member is invalid, setting not to allow the transaction.

5. The credit transaction system of claim 4, further comprising an update unit configured to update an adjustment rate for a member based on payment information of the member.

6. The credit transaction system of claim 2 wherein said determination unit determines whether or not to adjust a credit limit of a member making an application for the application based on a deposit classification set for the member.

7. The credit transaction system of claim 6, further comprising:
a unit configured to determine a payment status of a member from payment information of the member; and
a unit configured to update a deposit classification set for the member based on the determination result of the payment status.

8. A credit transaction method to be conducted on a computer, said method comprising the steps of:
calculating an adjusted unused balance based on a preset adjustment rate for a credit limit of a member applying for a credit transaction; and
setting whether or not to allow the transaction based on a comparison result between the calculated adjusted unused balance and a transaction amount.

9. The credit transaction method of claim 8, further comprising the step of determining, in response to an application for a credit transaction, whether or not to adjust a credit limit of a member making the application based on payment information of the member,
wherein said step of calculating an adjusted unused balance is conducted in the case of determining to adjust the credit limit of the member.

10. A computer readable medium bearing a credit transaction program for causing a computer to execute the steps of a credit transaction method according to claim 8.

11. A credit transaction program for causing a computer to execute the steps of a credit transaction method according to claim 8.
